(19) United States
(12) Patent Application Publication
(10) Pub. No.: US 2023/0228182 A1
(43) Pub. Date: Jul. 20, 2023

(54) REAL-TIME EVAL OPTIMIZES DRILLING OPERATIONS EFFICIENCY

(71) Applicant: Saudi Arabian Oil Company, Dhahran (SA)

(72) Inventors: Mohammed Murif Hassan Al-Rubaii, Dammam (SA); Saleh Mohammed Al-Harbi, Dhahran (SA)

(21) Appl. No.: 17/579,103

(22) Filed: Jan. 19, 2022

(51) Int. Cl. E21B 44/04; E21B 44/06; E21B 45/00; E21B 21/08; G05B 13/04

(52) U.S. Cl. CPC E21B 44/04; E21B 44/06; E21B 45/00; E21B 21/08; G05B 13/042; E21B 2200/20

(57) ABSTRACT

Systems and methods include a computer-implemented method for optimizing well drilling operations. An estimate for a maximum safe rate of penetration (ROP) is determined based on cutting concentrations in annulus (CCA) values. Hydraulics of mud pump+bit and jet impact force hydraulics are evaluated. A developed hole cleaning index is determined based on a carrying capacity model considering chemical and physical influences of drilling fluid rheology. A real-time Drilling Specific Energy (DSE) is determined using the estimate for the maximum safe ROP, the evaluated hydraulics, and the developed hole cleaning index. Optimal drilling parameters are determined using particle swarm optimization (PSO) and a penalty approach (PA). Optimal mechanical drilling parameters are determined using the optimal drilling parameters and by evaluating the real-time DSE. The optimal mechanical drilling parameters are used during drilling. The real-time developed DSE is correlated with fuel consumption to assess CO₂ and toxics gases emission.

### TECHNICAL FIELD

The present disclosure applies to optimizing drilling operations.

### BACKGROUND

The efficiency of drilling operations, such as for drilling an oil well, can be affected by many factors. Some of the factors are associated with the performance of rig equipment. Other factors are associated with the types of geology that encountered by the drill bit. Factors that affect the drilling operations include, for example, fluid densities, drilling rates, and hole cleaning efficiency.

### SUMMARY

The present disclosure describes techniques that can be used for optimizing drilling operations. In some implementations, a computer-implemented method includes the following. An estimate for a maximum safe rate of penetration (ROP) is determined for a well based on cutting concentrations in annulus (CCA) values within a predefined range. Hydraulics of mud pump+bit and jet impact force hydraulics are evaluated for the well. A developed hole cleaning index is determined for the well based on a carrying capacity model considering chemical and physical influences of drilling fluid rheology. A real-time Drilling Specific Energy (DSE) is determined for the well using the estimate for the maximum safe ROP, the evaluated hydraulics, and the developed hole cleaning index. Optimal drilling parameters are determined for the well using particle swarm optimization (PSO) and a penalty approach (PA). Optimal mechanical drilling parameters are determined for the well using the optimal drilling parameters and by evaluating the real-time DSE. The optimal mechanical drilling parameters are used during drilling. The real-time developed DSE is correlated with fuel consumption to assess CO₂ and toxics gases emission for environmental awareness.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. Technical improvements include: evaluating rig and bit hydraulics efficiency, improving drilling rates, generating real-time profiles (without the need for commercialized software or devices), reducing fuel consumption, minimizing maintenance periods of rig equipment, and contributing to environmental improvements including saving trees and reducing toxic gas and CO₂ emissions. Real-time downhole values can be obtained while drilling a well without the cost of commercial software. Proper and optimum hole cleaning performance can be ensured, which will improve drilling efficiency. Drilling troubles, such as lost circulation, stuck pipe, and well control, can be minimized. Fast rig operations performance can be improved. Unnecessary operations, such as reaming and wiper trips, can be reduced. Excessive use of sweeping materials can be minimized. Drilling performance output efficiency can be maximized. The optimum total flow area and nozzle size of selected drill bit can be recognized. Fuel consumption by the rig can be reduced. Time required for maintenance can be reduced. Gases, including CO₂ emissions, can be reduced. Using a real-time model of drilling specific energy (DSE) can minimize stuck pipe incidents (e.g., due to bad hole cleaning), improve drilling rates, and minimize non-productive times. A real-time model provides the ability for using rig and bit hydraulics as real-time profiles, without the need for extra logging tool, external devices, or human interaction. The techniques can improve drilling operation efficiency evaluations and recommendations. The use of a penalty approach to shift the selection of optimal drilling parameters to the area of optimization can maximize the effects of drilling parameters. The particle swarm optimization (PSO) approach can guide the solution towards the optimal one (e.g., in a predetermined maximum and minimum range) until a minimum value of DSE is achieved. By using the penalty approach in the objective function code, the DSE will be optimized, which will eventually drag the parameter to the optimal values. The eventual results of optimization include reducing drilling time and reducing costs. Decreasing drilling time can be attained by maximizing the rate of penetration (ROP) through drilling with the best parameters. The lifespan of drilling rig equipment can be increased.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flow diagram of an example of a workflow for optimizing drilling parameters, according to some implementations of the present disclosure.

FIG. 2 is a diagram of an example of a workflow for optimizing drilling efficiency, according to some implementations of the present disclosure.

FIG. 3 is a graph of an example plot of depth versus ROP, according to some implementations of the present disclosure.

FIG. 4 is a graph of an example plot of depth versus MSE (Teale), according to some implementations of the present disclosure.

FIG. 5 is a graph of an example plot of depth versus MSE (Armenta), according to some implementations of the present disclosure.

FIG. 6 is a graph of an example plot of depth versus MSE (Al-Rubaii), according to some implementations of the present disclosure.

FIG. 7 is a graph of an example comparison of plots of depth versus MSE, according to some implementations of the present disclosure.

FIG. 8 is a graph of an example plot of MSE versus DSE, according to some implementations of the present disclosure.

FIG. 9 is a graph of an example plot of MSE ratio (Teale) versus MSE ratio (Armenta), according to some implementations of the present disclosure.

FIG. 10 is a graph of an example plot of MSE ratio (Teale) versus DSE ratio (Al-Rubaii), according to some implementations of the present disclosure.

FIG. 11 is a graph of an example plot of MSE ratio (Armenta) versus DSE ratio (Al-Rubaii), according to some implementations of the present disclosure.

FIG. 12 is a graph of an example plot of depth versus MSE and DSE ratios, according to some implementations of the present disclosure.

FIG. 13 is a graph of an example plot of engine exhaust emissions by well, according to some implementations of the present disclosure.

FIG. 14 is a graph of an example of average fuel consumption, according to some implementations of the present disclosure.

FIG. 15 is a graph of an example of average fuel consumption per well, according to some implementations of the present disclosure.

FIG. 16 is a graph of an example of average CO₂ emissions per well, according to some implementations of the present disclosure.

FIG. 17 is a graph of an example of average trees saved per year, according to some implementations of the present disclosure.

FIG. 18 is a flowchart of an example of a method for determining optimal mechanical drilling parameters are determined for the well using the optimal drilling parameters and by evaluating the real-time DSE, according to some implementations of the present disclosure.

FIG. 19 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for optimizing drilling operations. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure can be used to develop real-time algorithms based on data mining techniques that are applied to enhance well drilling and rig performance through real-time drilling operations efficiency optimization. Optimization can be defined, for example, as achieving an improvement or level of production above a pre-defined level or percentage increase. The term real-time can correspond, for example, to events that occur within a specified period of time, such as within one minute or within one second. The developed model uses real-time algorithmic equations that provides a drilling specific energy profile in real-time. The use of models makes it possible for the drilling team to continuously monitor, evaluate and advise well drilling efficiency while drilling to avoid hole problems and optimize well drilling and rig performance. The models can also facilitate immediate intervention when the wellbore is not utilizing proper drilling energy and can provide information about input drilling energy evaluation and rate of penetration (ROP, e.g., in feet/hour) performance optimization. The models automatically calculate the modified drilling specific energy (DSE, e.g., in pounds per square inch, psi). A real-time DSE model can combine mechanical drilling parameters, drilling fluid rheological parameters, and hole cleaning efficiency to generate real-time information used by the drilling team. As a result, the drilling team can recognize the ability of rig & bit hydraulics to circulate the cuttings to the surface and ensure a smooth, optimized rate of penetration and proper optimized drilling specific energy that is relative with rig & bit efficiency and equipment limitations. Surface rig sensors and mud rheological properties can be used to interpret downhole conditions by using the developed real-time models. The models can consider the drilling fluids density, rheology and drilling rate with others rig sensors as an input in addition to some general well data to display the DSE as a real-time curve for the drilling team's assessment and intervention under one general real-time profile DSE. The real-time algorithmic model provides drilling teams with continuous monitoring, evaluation, and optimization regarding rig performance & efficiency. This helps mitigate hole problems and improves drilling rate resulting in safer and economical wells. Also, DSE can indicate optimal mechanical drilling parameters for optimal usage of fuel consumption and reduced periods of maintenance. Particle swarm optimization (PSO) can be applied with a penalty approach (PA) to automatically selected and assign optimized areas drilling parameters. The developed models can have impact on environmental awareness regarding fuel consumption, saving trees and reducing toxic gases emissions.

The real-time model can be developed using a real-time data driven approach and a sense of physics. The real-time algorithmic model can be developed by collecting data and trying to derive best models. Algorithms based on data mining techniques can be applied to enhance well drilling and rig performance through real-time drilling specific energy efficiency optimization. The models can provide automated model information (e.g., DSE) in real-time. Use of the models allows the drilling team to continuously monitor, evaluate, and advise hydraulics efficiency while drilling to avoid hole problems and to optimize well drilling performance. The models allow for the immediate intervention when the wellbore drilling performance is not efficient by providing notifications to optimize operations, including applying drilling energy for ROP performance improvement. These techniques can provide an enhanced well drilling performance, which can be useful in the mitigation of stuck pipe incidents.

Techniques that are used can impact the drilling rate, which will ensure optimal performance and mitigate stuck pipe problems. The techniques can be used to maximize the ROP by optimizing drilling parameters. The drilling parameters can include revolutions per minute (RPMs), wait on bit (WOB, e.g., in kilo-pounds (klb)), flow rate in gallon per min (GPM), torque (TRQ, e.g., in foot-pounds, ft-lb), and stand pipe pressure (SPP, e.g., in psi). As long as the cutting concentrations in annulus (CCA) is less than 0.05%, the techniques of the present disclosure can be used to determine an optimized ROP in conjunction with a minimized DSE, yielding ideal RPM and WOB values and reducing the drilled cost per foot. The developed methodology can assist drilling engineering in selecting improved drilling parameters by optimizing the drilling specific energy using a particles swarm optimization (PSO) method with a penalty approach (PA). Evidence of the efficiency of the such techniques can be provided by comparing the ROP and DSE measured for a vertical, deviated and horizontal hole section drilled employing the technique with data for an offset well drilled in a non-optimized fashion.

### Particles Swarm Optimization

Particle swarm optimization (PSO) can be defined as a computational process which will enhance a given problem by performing many trials and tests to optimize a proposed solution that is relevant with a special measure of quality. The optimization process of PSO begins with having a large number of proposed solutions referred to as particles. Then, the particles can be searched based on mathematical laws for position and velocity of particles. Movements of a proposed solution can initially begin with a local, best-known position. Then the proposed solution can aim toward a best matching position in a search space. Then, movement of the swarm can be towards a best proposed solutions. PSO was first intended for estimating the behavior of society as a representative style of the movement of organisms in a flock of birds or a school of fish. The algorithm was simplified and was discovered to provide enhancements.

PSO can make a few or no assumptions about the problem that is being enhanced, which results in a very large space of proposed solutions. However, PSO cannot ensure an exact solution is ever found. In particular, PSO does not use the gradient of the problem which is being optimized. This means that PSO does not ask for the enhancement of problem to be different as is required by classic optimization methods such as gradient descent and quasi-newton methods. PSO also makes use of optimization of problems that are partially irregular, noisy, or change over time.

### The Penalty Approach

The penalty approach can be described as a process for converting a controlled optimization problem into a categorization of unconfined problems. After dividing a main problem into a sequence of unconstrained optimization problems, the penalty approach is introduced based on the degree of constraint violation and reflecting the requirements for design variables.

Some penalty methods can include logarithmic obstructions and exponential penalty approaches which outline a constantly differentiable prehistoric line to linearly constrain convex problems. For example, a penalty approach can be used to avoid unwanted values of used real-time data. A penalty can be applied on an unwanted value to prevent the unwanted value from being considered in the model. Additional penalty techniques can be used for nonlinear optimization. The possibility of penalty parameter adjustment is introduced by these techniques by controlling the degree of linear practicability produced for each iteration. An updated penalty plan can be shown in the context of sequential quadratic programming and sequential linear-quadratic programming methods by the utilization of trust regions to promote convergence.

Some penalty methods are introduced for the purpose of solving optimal control problems using steady-state and time-needy equations. These methods can be compared numerically in two versions with the addition of generalized penalty methods to the time-reliant case. Both approaches of semi and fully discrete approximations for time-dependent Dirichlet control problems can be used. Also, the existence of reported numerical results for solving both the steady-state and the time dependent Dirichlet control problems. Based on the literature review, CCA is an important tool to be considered to ensure optimized ROP performance and effective DSE.

### Particle Swarm Optimization (PSO) Technique and Penalty Approach

This method is based on PSO method to calculate the optimal drilling parameters, but is improved by incorporating a penalty approach. Particle swarm optimization (PSO) does not make any assumption about the problem or guarantee if the problem was optimized. Therefore, it is used usually for problems that are partially irregular, noisy, or change over time. Where PSO algorithm represented according to the following equality:

V_{id}^{k+1}=v_{id}^{k}+c₁r₁^{k}(pbest_{id}^{k}−x_{id}^{k})+c₂r₂^{k}(gbest_{d}^{k}−x_{id}^{k}) (1)

X_{id}^{k+1}=x_{id}^{k}+v_{id}^{k+1} (2)

where k is a flow consistency index, and where: 1) V_{id}^{k} and x_{id}^{k} stand separately for the speed of the particle “i” at its “k” times and the “d” dimension quantity of its position; 2) pbest_{id}^{k} represents d-dimension quantity of individual ‘i” at its most optimist position at its “k” times; and 3) gbest_{id}^{k} represents the d-dimension quantity of the swarm at its most optimist position at its “k” times.

In order to avoid particle being far away from the searching space, the speed of the particle created at each direction is confined between −vdₘₐₓ, and vdₘₐₓ. If the number of vdₘₐₓ is too big, the solution is far from the best. If the number of vdₘₐₓ is too small, the solution will be the local optimism. Also, c₁ and c₂ represent the speeding figure, regulating the length when flying to the most particle of the whole swarm and to the most optimist individual particle. If the figure is too small, the particle is probably far away from the target field, if the figure is too big, the particle will maybe fly to the target field suddenly or fly beyond the target field.

The proper figures for c₁ and c₂ can control the speed of the particle's flying and the solution will not be a partial optimization. Usually, c₁ is equal to c₂ and they are equal to 2. r₁ and r₂ represent random numbers, and 0-1 is a random number. For the other technique, the penalty method is used for converting a constrained optimization problem into a sequence of unconstrained problems. In the penalty approach, three equations have been applied to control the data to obtain the optimal drilling parameters, which are WOB and RPM of the area of optimization. The three equations contain TRQ, Wait On Bit (WOB), RPMs and CCA values. The first equation represents the penalty approach by using TRQ, maximum torque (TRQₘₐₓ) of used drill pipe in certain hole section and mean value of torque data (TRQₘₑₐₙ). The penalty approach was used to make sure not to exceed the maximum torque. The penalty approach was used to ensure the selected values do not exceed 25 KIb-ft and are more than 5 KIb-ft. The second equation represents a penalty approach by using WOB, maximum WOB (WOBₘₐₓ), and mean value of WOB values (WOBₘₑₐₙ). The penalty approach was used to make sure not to exceed the maximum WOB. The penalty approach was used to make sure the minimum selected value is 3 KIb and does not exceed 45 KIb. The third equation represents CCA, maximum CCA (CCAₘₐₓ) and the mean values of CCA (CCAₘₑₐₙ). The Penalty Approach was used to ensure the selected value does not exceed 0.05 and is more than 0.03. The fourth equation represents the penalty approach by using of RPMs, maximum RPMs (RPMₘₐₓ) and mean value of RPM values (RPMₘₑₐₙ). The penalty approach was used to make sure not to exceed the maximum RPMs. The penalty approach was used to make sure the minimum selected value is 50 RPMs and does not exceed 250 RPMs.

The following equations were applied to determine the objective (OBJ) function:

OBJ=DSE+Penalty (3)

where:

OBJ=DSE+P1+P2+P3+P4 (4)

where, P1, P2, P3, and P4 are penalties.

P1 is the torque term, where:

$$P 1 = {( \frac{TRQ - TRQmax}{TRQmean} )}^{2} , IF TRQ > TRQmax and 0 if TRQ <= TRQmax . \qquad ( 5 )$$

P2 is the WOB term, where:

$$P 2 = {( \frac{WOB - WOBmax}{WOBmean} )}^{2} , IF WOB > WOBmax and 0 if WOB <= WOBmax . \qquad ( 6 )$$

P3 is the CCA term, where:

$$P 3 = {( \frac{CCA - CCAmax}{CCAmean} )}^{2} , IF CCA > CCAmax and 0 if CCA <= 0.05 . \qquad ( 7 )$$

P4 is the RPM term, where:

$$P 4 = {( \frac{RPM - RPMmax}{RPMmean} )}^{2} , IF RPM > RPMmax and 0 if RPM <= RPMmax \qquad ( 8 )$$

Matlab codes were developed to obtain the improvement. Three codes were established to the main code, the PSO code and the DSE function code (include the penalty approach). Based on the calculation, the optimal parameters that reduce the DSE were determined.

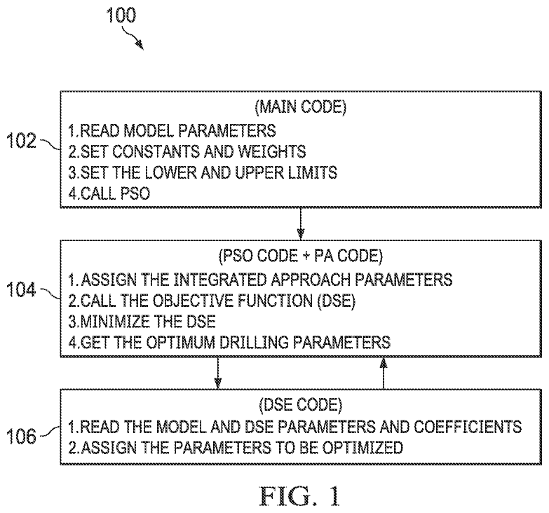

FIG. 1 is a flow diagram of an example of a workflow 100 for optimizing drilling parameters, according to some implementations of the present disclosure. The flow chart in shows the optimization procedure followed in the present disclosure. In main code 102, the data is read, tested for quality, and examined. The constants and weights are set and the lower and upper limits for the parameters are also set. At 104, through the PSO code, the drilling parameters are assigned, and the objective function is called for optimization. At 106, DSE code is used to read the model and DSE parameters and coefficients, and parameters to be optimized are assigned.

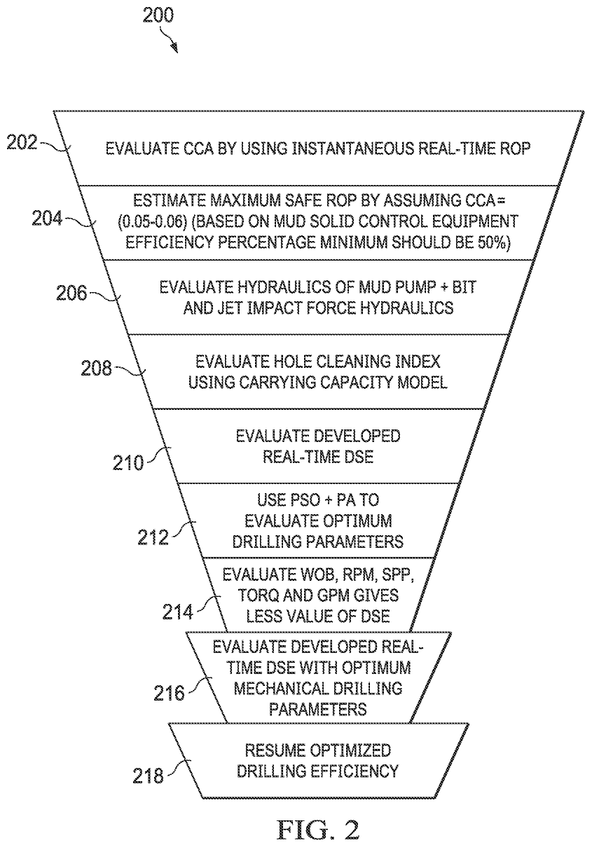

FIG. 2 is a diagram of an example of a workflow 200 for optimizing drilling efficiency, according to some implementations of the present disclosure. At 202, CCA is evaluated by using real-time instantaneous ROP. At 204, minimum safe ROP is estimated by assuming the CCA is in the range of [0.05-0.06]. Based on mud solid control equipment efficiency, the percentage minimum should be 50%. At 206, the hydraulics of mud pump+bit and jet impact forces are evaluated. At 208, the hole cleaning index is evaluated using a carrying capacity model. At 210, the developed real-time DSE is evaluated. At 212, PSO and PA are used to evaluate optimum drilling parameters. At 214, WOB, RPM, SPP, TRQ, and GPM are evaluated to provide a lesser value of DSE. At 216, the developed real-time DSE is evaluated with mechanical drilling parameters.

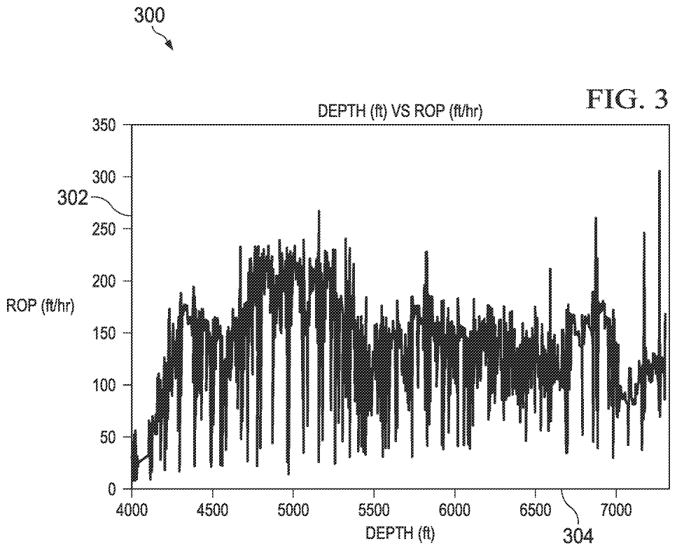

FIG. 3 is a graph 300 of an example plot of depth versus ROP, according to some implementations of the present disclosure. Elements of the graph 300 are plotted relative to ROP 302 (e.g., in feet/hour) and depth 304 (e.g., in feet).

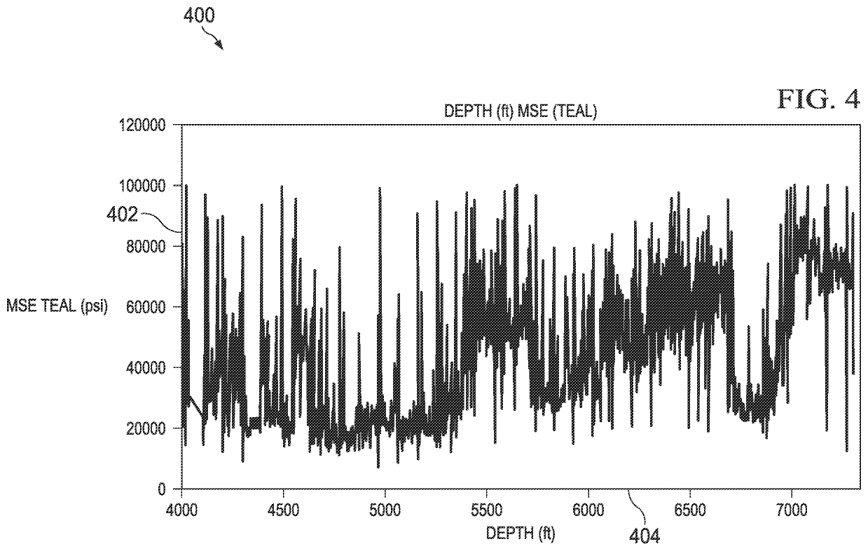

FIG. 4 is a graph 400 of an example plot of depth versus MSE (Teale), according to some implementations of the present disclosure. Elements of the graph 400 are plotted relative to MSE 402 (e.g., in psi) and a depth 404 (e.g., in feet).

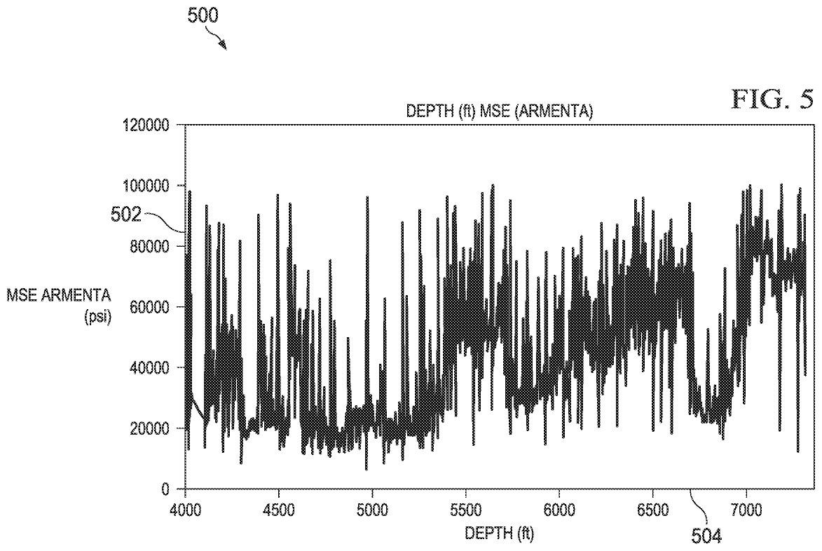

FIG. 5 is a graph 500 of an example plot of depth versus MSE (Armenta), according to some implementations of the present disclosure. Elements of the graph 500 are plotted relative to MSE 502 (e.g., in psi) and depth 504 (e.g., in feet).

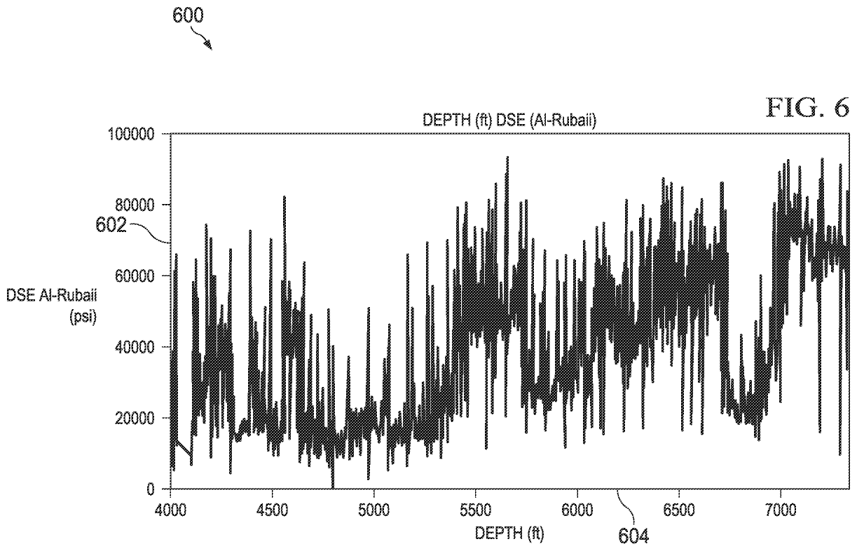

FIG. 6 is a graph 600 of an example plot of depth versus MSE (Al-Rubaii), according to some implementations of the present disclosure. Elements of the graph 600 are plotted relative to DSE 602 (e.g., in psi) and depth 604 (e.g., in feet).

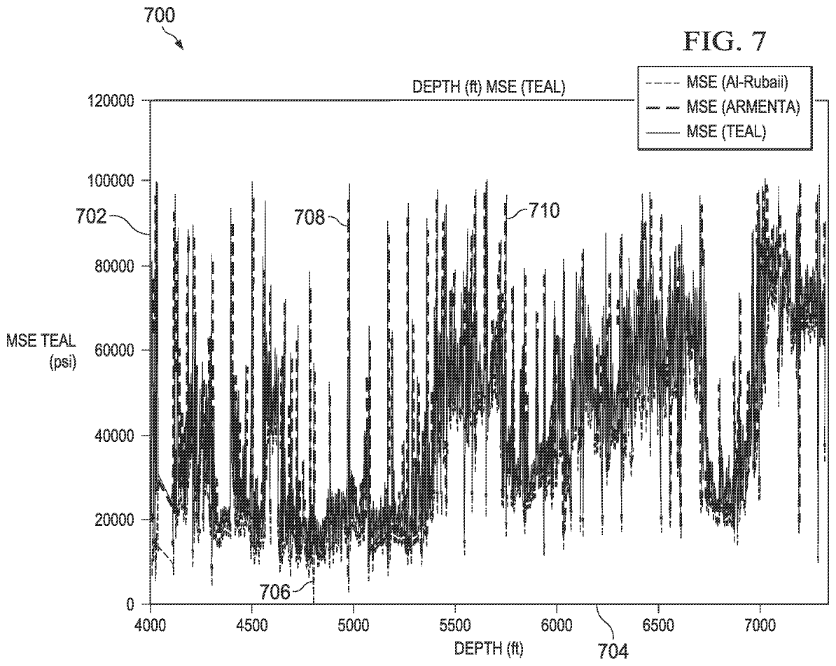

FIG. 7 is a graph 700 of an example comparison of plots of depth versus MSE, according to some implementations of the present disclosure. Elements of the graph 700 are plotted relative to MSE 702 (e.g., in psi) and depth 704 (e.g., in feet). The elements include an MSE (Al-Rubaii) plot 706, an MSE (Armenta) plot 708, and an MSE (Teale) plot 710.

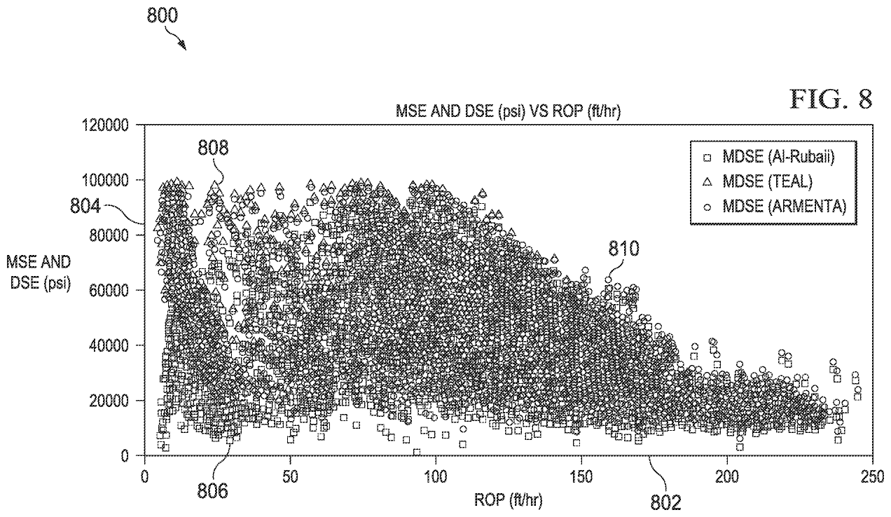

FIG. 8 is a graph 800 of an example plot of MSE versus DSE, according to some implementations of the present disclosure. Elements of the graph 800 are plotted relative to ROP 802 (e.g., feet/hour) and MSE and DSE 804 (e.g., in psi). The graph 800 includes an MSE (Al-Rubaii) plot 806, an MSE (Teale) plot 808, and an MSE (Armenta) plot 710.

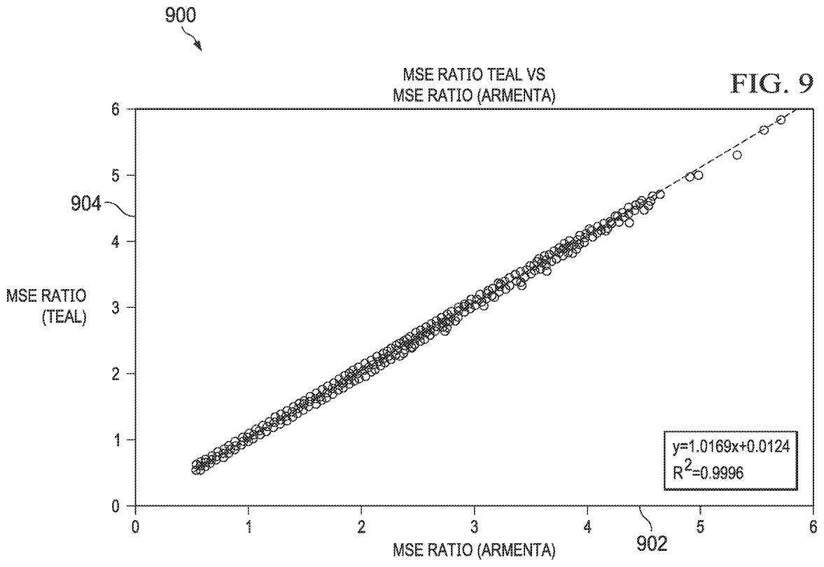

FIG. 9 is a graph 900 of an example plot of MSE ratio (Teale) versus MSE ratio (Armenta), according to some implementations of the present disclosure. Elements of the graph 900 are plotted relative to MSE ratio (Armenta) 902 and MSE ratio (Teale) 904.

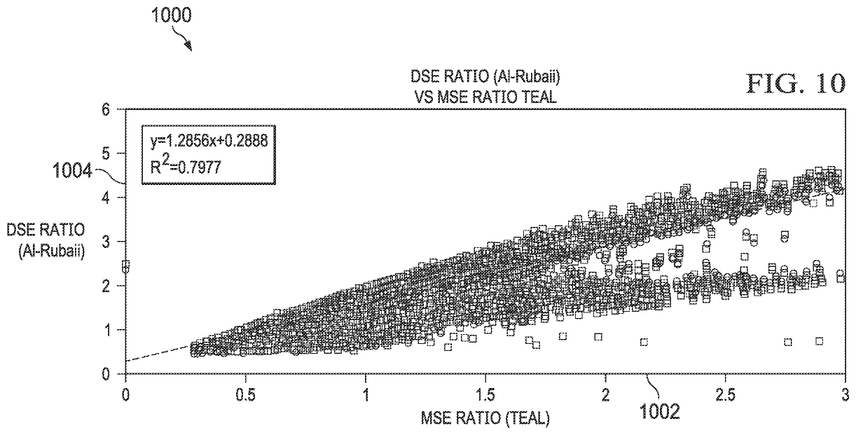

FIG. 10 is a graph 1000 of an example plot of MSE ratio (Teale) versus DSE ratio (Al-Rubaii), according to some implementations of the present disclosure. Elements of the graph 1000 are plotted relative to MSE ratio (Teale) 1002 and DSE ratio (Al-Rubaii) 1004.

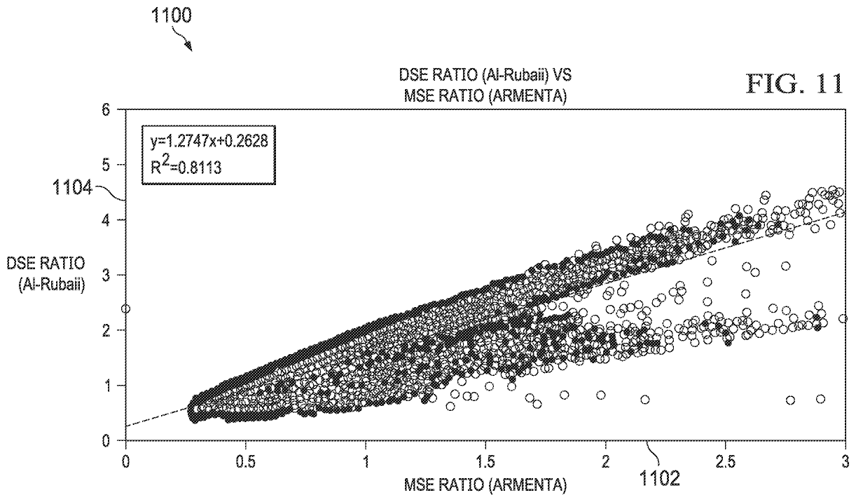

FIG. 11 is a graph 1100 of an example plot of MSE ratio (Armenta) versus DSE ratio (Al-Rubaii), according to some implementations of the present disclosure. Elements of the graph 1100 are plotted relative to MSE ratio (Armenta) 1102 and DSE ratio (Al-Rubaii) 1104.

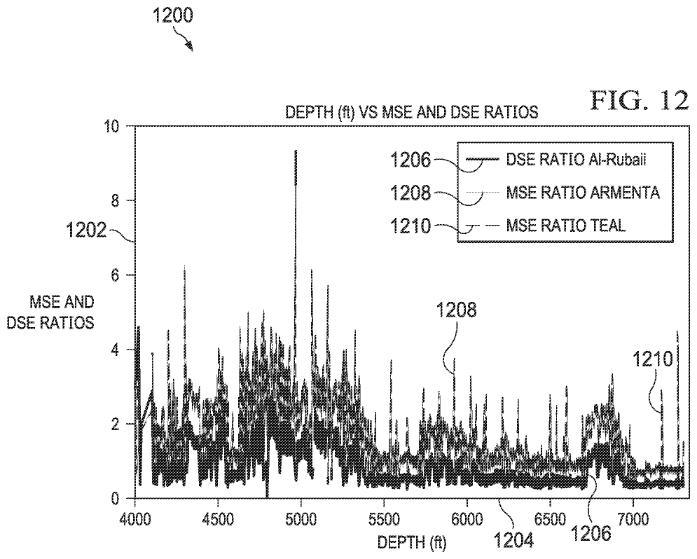

FIG. 12 is a graph 1200 of an example plot of depth versus MSE and DSE ratios, according to some implementations of the present disclosure. Elements of the graph 1200 are plotted relative to ratios 1102 and depth 1104 (e.g., in feet). The graph 1200 includes an DSE (Al-Rubaii) ratio plot 1206, an MSE ratio (Armenta) plot 1208, and an MSE ratio (Teale) plot 1210.

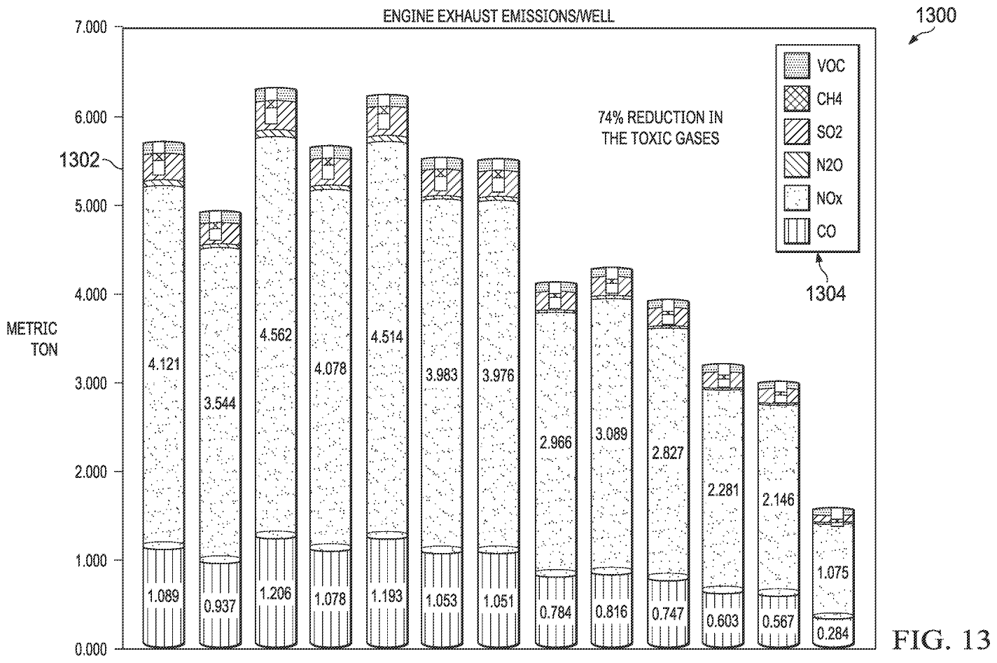

FIG. 13 is a graph 1300 of an example plot of engine exhaust emissions by well, according to some implementations of the present disclosure. Elements of the graph 1300 are plotted relative to metric tons of emissions 1302. Components 1304 indicate shading for different components of the emissions for each well.

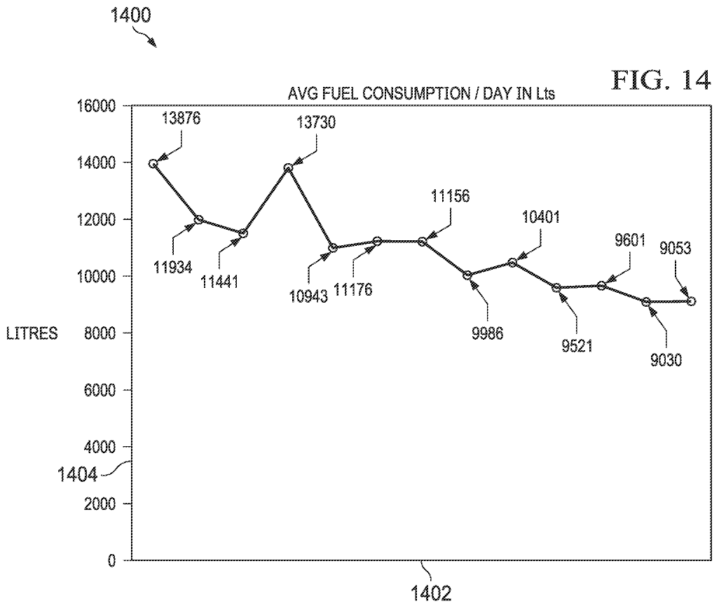

FIG. 14 is a graph 1400 of an example of average fuel consumption, according to some implementations of the present disclosure. Elements of the graph 1400 are plotted relative to time 1402 and fuel consumed 1404 (e.g., in liters). As shown in the graph 1400, using automatic engine power management results in an average savings of 34% less fuel consumption per day.

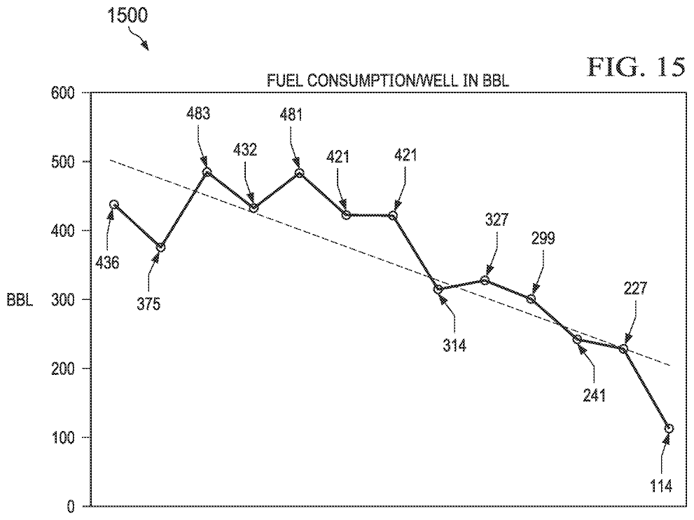

FIG. 15 is a graph 1500 of an example of average fuel consumption per well, according to some implementations of the present disclosure. Elements of the graph 1500 are plotted relative to time 1502 and fuel consumed 1504 (e.g., in barrels per day (bbl)). As shown in the graph 1500, using automatic engine power management results in an average savings of 74% less fuel consumption per well per day.

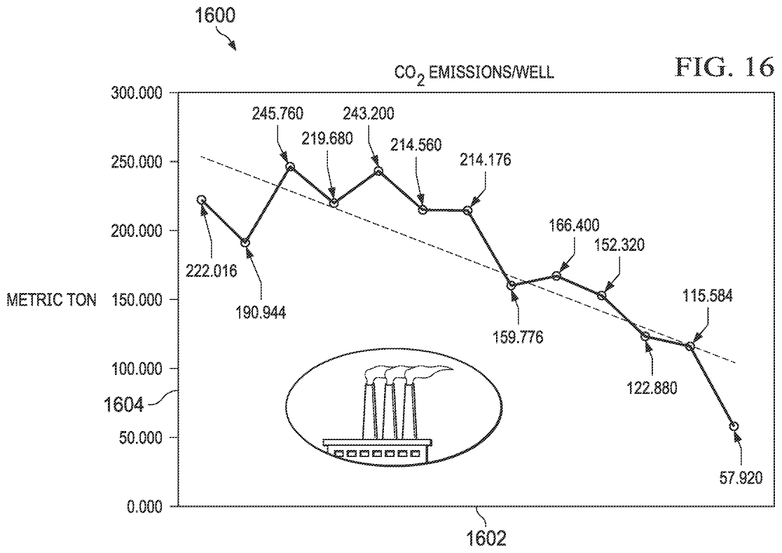

FIG. 16 is a graph 1600 of an example of average CO₂ emissions per well, according to some implementations of the present disclosure. Elements of the graph 1600 are plotted relative to time 1602 and metric tons of CO₂ emissions 1604. As shown in the graph 1600, using automatic engine power management results in an average reduction of CO₂ emissions of 74%.

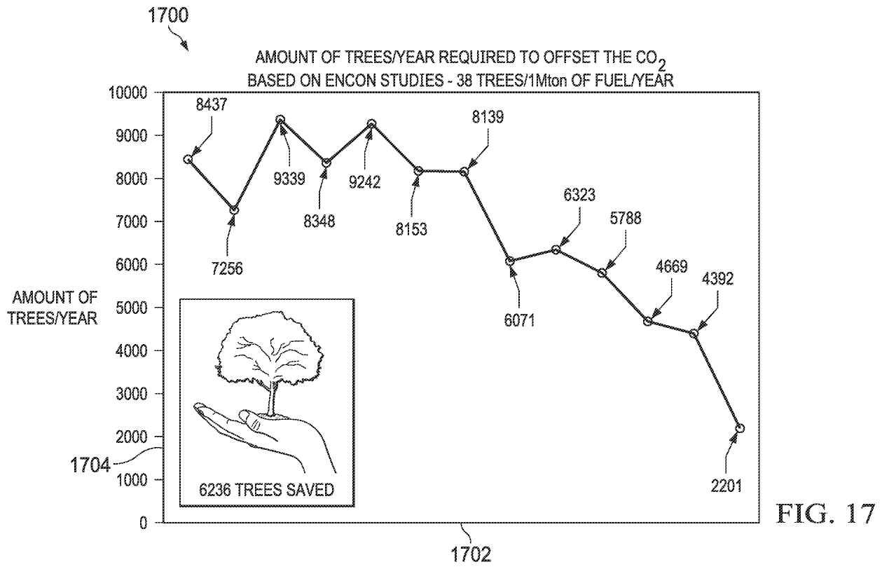

FIG. 17 is a graph 1700 of an example of average trees saved per year, according to some implementations of the present disclosure. Elements of the graph 1700 are plotted relative to time 1702 and a number of trees 1704. As shown in the graph 1700, using automatic engine power management results in an average savings of 6236 trees per year. This number is determined based on a number of trees per year required to offset the CO2 based on studies, where 38 trees=1 metric ton of fuel per year.

### Real-Time Developed Equations

In some implementations, V_{cr}, the cutting rise velocity (ft/min) is given by:

$${V}_{cr} = \frac{60}{( 1 - {( \frac{OD}{OH} )}^{2} ) * ( 0.6 + \frac{18.2}{ROP} )} \qquad ( 9 )$$

Vₐₙₙ, the annular velocity (e.g., in ft/min) is given by:

$${V}_{ann} = \frac{24.5 GPM}{{OH}^{2} - {OD}^{2}} \qquad ( 10 )$$

In some implementations, Vannc, the corrected Annular velocity (ft/min), is given by:

$$Vannc = \frac{( Vann + Vcc + Vcr - Vcs )}{4} Cos ( HA ) + \frac{( Vann + Vcc + Vcr - Vcs )}{4} Sin ( HA ) \qquad ( 11 )$$

In some implementations, Vcs, the cuttings slip velocity (e.g., in ft/min), is given by:

$${V}_{cs} = 175 ( \frac{0.2 ( \frac{ROP}{RPM} ) {( 21.5 - \frac{MW}{7.5} )}^{0.667}}{{( \frac{MW}{7.5} )}^{0.333} {( \frac{MW / 7.5}{64} ( MF - 28 ) )}^{0.333}} \qquad ( 12 )$$

where MW is the mud weight or drilling fluid density (PCF) and MF is the march funnel viscosity (lbs/100 ft).

In some implementations, Vcc, the critical cuttings velocity due to ROP (ft/min)

$${V}_{cc} = \frac{ROP ( {OH}^{2} )}{183} \qquad ( 13 )$$

In some implementations, the cutting concentrations in annulus (CCA), is given by:

$$CCA = 0.0014 \frac{ROP ( {OH}^{2} )}{GPM} \qquad ( 14 )$$

In some implementations, the Max. Safe Limit ROP is given by:

$$Max . Safe Limit ROP = \frac{35 GPM}{{OH}^{2}} \qquad ( 15 )$$

In some implementations, the Carrying Capacity Index (CCI), which is a hole cleaning index to evaluate hole cleaning efficiency while drilling, is given by:

$$CCI = \frac{EMW K Vannc}{5871} \qquad ( 16 )$$

where:

$$n = 3.32 log ( \frac{2 PV + YP + \frac{ES}{400} + \frac{GSf}{GSi} + \frac{PH}{9}}{PV + YP + LSYP + \frac{ES}{400} + \frac{GSf}{GSi} + \frac{PH}{9}} ) \qquad ( 17 )$$

where PV is the plastic viscosity (e.g., cp), YP is the yield point (e.g., in cp), ES is the electrical stability (e.g., in volts), GSf is the final gel strength, GSi is the initial gel strength, PH is the hydrogen measurement for basicity and acidity, and LSYP is the low shear yield point.

$$K = \frac{PV + YP + LSYP}{{511}^{n}} \qquad ( 18 )$$

where n is a flow behavior index and where equivalent mud weight is given by:

(EMW)=MW(CCA)+MW.

In some implementations, HSImp, the hydraulics square inch of mud pump influences, is given by:

$$HSImp = 0.00074 SPP \frac{GPM}{{OH}^{2}} \qquad ( 19 )$$

In some implementations, the hydraulics square inch of bit influences (HSIb) is given by:

$$HSIb = 0.00074 dpb \frac{GPM}{{OH}^{2}} \qquad ( 20 )$$

where drill bit pressure loss (dbp) is given by:

$$dpb = \frac{{EMWGPM}^{2}}{81000 {TFA}^{2}} \qquad ( 21 )$$

where total flow area (TFA) is given by:

$$TFA = \frac{3.14}{4} n 1 {( \frac{d 1}{32} )}^{2} + \frac{3.14}{4} n 2 {( \frac{d 2}{32} )}^{2} + \frac{3.14}{4} {n ( \frac{di}{32} )}^{2} + … + \frac{3.14}{4} {ni ( \frac{di}{32} )}^{2}$$

In some implementations, JIF, the jet Impact force of bit (e.g., in lbs), is given by:

JIF=0.00633 GPM(EMWdpb)^{0.5} (22)

In some implementations, mechanical specific energy (MSE), is given

$$MSE = ( \frac{Input Energy}{Out ROP} ) \qquad ( 23 )$$

$$or :$$

$$MSE = ( \frac{480 T or RPM}{{D}_{B}^{2} ROP} + 1.273 \frac{WOB}{{D}_{B}^{2}} ) ( Teale 1965 ) \qquad ( 24 )$$

where D_{B} is a bit diameter (e.g., in inches), or:

$$MSE = ( \frac{120 Π Tor RPM}{{A}_{B} ROP} + \frac{WOB}{{A}_{B}} - \frac{1980000 λ HHPbit}{( {A}_{B} ROP )} ) ( Armenta 2008 ) \qquad ( 25 )$$

where A_{B} is the bit area (e.g., in square inches):

$$x = \frac{CCI + CCA}{CCI - CCI ( CCA )} ( Hole cleaing Influence constant ) \qquad ( 26 )$$

$$and :$$

$$DSF = \frac{1.27 ( WOB - JIF )}{{OH}^{2}} + \frac{480 RPM TORQ}{{OH}^{2} ROP} - \frac{3 , 189 , 335 {( HSIb * ( HSImp + JIFSI ) )}^{X}}{{OH}^{2} ROP} \qquad ( 27 )$$

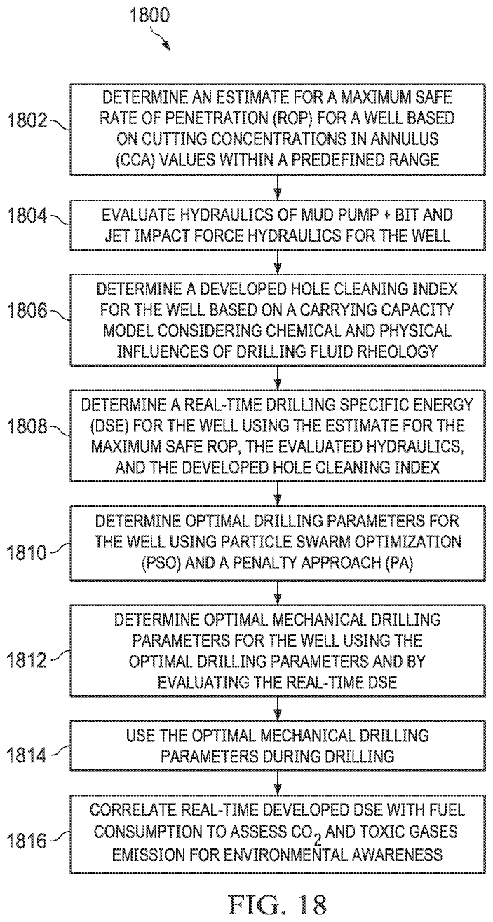

FIG. 18 is a flowchart of an example of a method 1800 for determining optimal mechanical drilling parameters are determined for the well using the optimal drilling parameters and by evaluating the real-time DSE, according to some implementations of the present disclosure. For clarity of presentation, the description that follows generally describes method 1800 in the context of the other figures in this description, including FIGS. 1-17. However, it will be understood that method 1800 can be performed, for example, by any suitable system, environment, software, and hardware, or a combination of systems, environments, software, and hardware, as appropriate. In some implementations, various steps of method 1800 can be run in parallel, in combination, in loops, or in any order.

At 1802, an estimate for a maximum safe rate of penetration (ROP) is determined for a well based on cutting concentrations in annulus (CCA) values within a predefined range. From 1802, method 1800 proceeds to 1804.

At 1804, hydraulics of mud pump+bit and jet impact force hydraulics are evaluated for the well. This can help in ensuring optimum hydraulics horsepower, which is a function of mud pump flow rate, stand pipe pressure, and mechanical and volumetric efficiency of a mud pump. Then, for bit and jet impact, force nozzle and jet velocity are the key factors. The bit and jet impact force are functions of hole size of drilled hole section, drilling fluid density used while drilling, the total flow area of jects and hydraulics horsepower of the drill bit. From 1804, method 1800 proceeds to 1806.

At 1806, a developed hole cleaning index is determined for the well based on a carrying capacity model considering chemical and physical influences of drilling fluid rheology. For example, the carrying capacity model can consider chemical and physical influences of drilling fluid rheology for vertical and directional wells. From 1806, method 1800 proceeds to 1808.

At 1808, a real-time Drilling Specific Energy (DSE) is determined for the well using the estimate for the maximum safe ROP, the evaluated hydraulics, and the developed hole cleaning index. In some implementations, the real-time DSE can be updated by evaluating weight on bit (WOB), revolutions per minute (RPMs), stand pipe pressure (SPP), torque (TRQ), and flow rate in gallon per min (GPM). In some implementations, determining the real-time DSE can include determining the real-time DSE based at least in part on the jet impact force of a bit. From 1808, method 1800 proceeds to 1810.

At 1810, optimal drilling parameters are determined for the well using particle swarm optimization (PSO) and a penalty approach (PA). For example, determining the optimal drilling parameters can include evaluating an objective function as a sum of the real-time DSE and a penalty. The penalty can be a sum of penalty terms, e.g., a torque term, a WOB term, a CCA term, and an RPM term. From 1810, method 1800 proceeds to 1812.

At 1812, optimal mechanical drilling parameters are determined for the well using the optimal drilling parameters and by evaluating the real-time DSE. PSO+PA can be applied, and the drilling optimum parameters can be used in the developed model, then proposed and applied in the developed algorithmic model. From this, the developed DSE can be evaluated, estimated, or calculated. From 1812, method 1800 proceeds to 1814.

At 1814, the optimal mechanical drilling parameters are used during drilling. PSO+PA can be used to assess the selected drilling parameters. Then the parameters can be proposed as optimum drilling parameters once the parameters have shown to have a positive effect on the rate of penetration and in minimizing drilling specific energy. From 1814, method 1800 proceeds to 1816.

At 1816, the real-time developed DSE is correlated with fuel consumption to assess CO₂ and toxics gases emission for environmental awareness. After 1816, method 1800 can stop.

Applying drilling specific energy can be used to show how much fuel is used during drilling. On the other hand, applying the developed DSE can show how much drilling specific energy was reduced and fuel consumption was measured as a result of applying the developed model. The developed model can be a real-time profile optimizer and analyzer, and can be used to achieve efficient energy consumption. The actual DSE can be compared with developed DSE, and the reduction percentage can be multiplied by the actual fuel used and then linked with CO₂ emissions reduction as a real-time profile. In summary, the techniques can be used to evaluate actual DSE, estimate developed DSE, measure actual fuel consumption, evaluate saved fuel consumption, evaluate CO₂ emissions by actual fuel consumption, and evaluate CO₂ emissions by saved fuel consumption.

In some implementations, in addition to (or in combination with) any previously-described features, techniques of the present disclosure can include the following. Customized user interfaces can present intermediate or final results of the above described processes to a user. The presented information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change or an improvement in drilling parameters (including speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

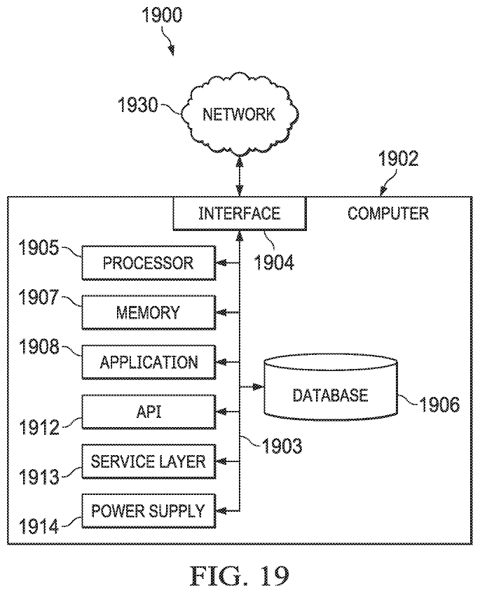

FIG. 19 is a block diagram of an example computer system 1900 used to provide computational functionalities associated with described algorithms, methods, functions, processes, flows, and procedures described in the present disclosure, according to some implementations of the present disclosure. The illustrated computer 1902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1902 can include input devices such as keypads, keyboards, and touch screens that can accept user information. Also, the computer 1902 can include output devices that can convey information associated with the operation of the computer 1902. The information can include digital data, visual data, audio information, or a combination of information. The information can be presented in a graphical user interface (UI) (or GUI).

The computer 1902 can serve in a role as a client, a network component, a server, a database, a persistency, or components of a computer system for performing the subject matter described in the present disclosure. The illustrated computer 1902 is communicably coupled with a network 1930. In some implementations, one or more components of the computer 1902 can be configured to operate within different environments, including cloud-computing-based environments, local environments, global environments, and combinations of environments.

At a top level, the computer 1902 is an electronic computing device operable to receive, transmit, process, store, and manage data and information associated with the described subject matter. According to some implementations, the computer 1902 can also include, or be communicably coupled with, an application server, an email server, a web server, a caching server, a streaming data server, or a combination of servers.

The computer 1902 can receive requests over network 1930 from a client application (for example, executing on another computer 1902). The computer 1902 can respond to the received requests by processing the received requests using software applications. Requests can also be sent to the computer 1902 from internal users (for example, from a command console), external (or third) parties, automated applications, entities, individuals, systems, and computers.

Each of the components of the computer 1902 can communicate using a system bus 1903. In some implementations, any or all of the components of the computer 1902, including hardware or software components, can interface with each other or the interface 1904 (or a combination of both) over the system bus 1903. Interfaces can use an application programming interface (API) 1912, a service layer 1913, or a combination of the API 1912 and service layer 1913. The API 1912 can include specifications for routines, data structures, and object classes. The API 1912 can be either computer-language independent or dependent. The API 1912 can refer to a complete interface, a single function, or a set of APIs.

The service layer 1913 can provide software services to the computer 1902 and other components (whether illustrated or not) that are communicably coupled to the computer 1902. The functionality of the computer 1902 can be accessible for all service consumers using this service layer. Software services, such as those provided by the service layer 1913, can provide reusable, defined functionalities through a defined interface. For example, the interface can be software written in JAVA, C++, or a language providing data in extensible markup language (XML) format. While illustrated as an integrated component of the computer 1902, in alternative implementations, the API 1912 or the service layer 1913 can be stand-alone components in relation to other components of the computer 1902 and other components communicably coupled to the computer 1902. Moreover, any or all parts of the API 1912 or the service layer 1913 can be implemented as child or sub-modules of another software module, enterprise application, or hardware module without departing from the scope of the present disclosure.

The computer 1902 includes an interface 1904. Although illustrated as a single interface 1904 in FIG. 19, two or more interfaces 1904 can be used according to particular needs, desires, or particular implementations of the computer 1902 and the described functionality. The interface 1904 can be used by the computer 1902 for communicating with other systems that are connected to the network 1930 (whether illustrated or not) in a distributed environment. Generally, the interface 1904 can include, or be implemented using, logic encoded in software or hardware (or a combination of software and hardware) operable to communicate with the network 1930. More specifically, the interface 1904 can include software supporting one or more communication protocols associated with communications. As such, the network 1930 or the interface's hardware can be operable to communicate physical signals within and outside of the illustrated computer 1902.

The computer 1902 includes a processor 1905. Although illustrated as a single processor 1905 in FIG. 19, two or more processors 1905 can be used according to particular needs, desires, or particular implementations of the computer 1902 and the described functionality. Generally, the processor 1905 can execute instructions and can manipulate data to perform the operations of the computer 1902, including operations using algorithms, methods, functions, processes, flows, and procedures as described in the present disclosure.

The computer 1902 also includes a database 1906 that can hold data for the computer 1902 and other components connected to the network 1930 (whether illustrated or not). For example, database 1906 can be an in-memory, conventional, or a database storing data consistent with the present disclosure. In some implementations, database 1906 can be a combination of two or more different database types (for example, hybrid in-memory and conventional databases) according to particular needs, desires, or particular implementations of the computer 1902 and the described functionality. Although illustrated as a single database 1906 in FIG. 19, two or more databases (of the same, different, or combination of types) can be used according to particular needs, desires, or particular implementations of the computer 1902 and the described functionality. While database 1906 is illustrated as an internal component of the computer 1902, in alternative implementations, database 1906 can be external to the computer 1902.

The computer 1902 also includes a memory 1907 that can hold data for the computer 1902 or a combination of components connected to the network 1930 (whether illustrated or not). Memory 1907 can store any data consistent with the present disclosure. In some implementations, memory 1907 can be a combination of two or more different types of memory (for example, a combination of semiconductor and magnetic storage) according to particular needs, desires, or particular implementations of the computer 1902 and the described functionality. Although illustrated as a single memory 1907 in FIG. 19, two or more memories 1907 (of the same, different, or combination of types) can be used according to particular needs, desires, or particular implementations of the computer 1902 and the described functionality. While memory 1907 is illustrated as an internal component of the computer 1902, in alternative implementations, memory 1907 can be external to the computer 1902.

The application 1908 can be an algorithmic software engine providing functionality according to particular needs, desires, or particular implementations of the computer 1902 and the described functionality. For example, application 1908 can serve as one or more components, modules, or applications. Further, although illustrated as a single application 1908, the application 1908 can be implemented as multiple applications 1908 on the computer 1902. In addition, although illustrated as internal to the computer 1902, in alternative implementations, the application 1908 can be external to the computer 1902.

The computer 1902 can also include a power supply 1914. The power supply 1914 can include a rechargeable or non-rechargeable battery that can be configured to be either user- or non-user-replaceable. In some implementations, the power supply 1914 can include power-conversion and management circuits, including recharging, standby, and power management functionalities. In some implementations, the power-supply 1914 can include a power plug to allow the computer 1902 to be plugged into a wall socket or a power source to, for example, power the computer 1902 or recharge a rechargeable battery.

There can be any number of computers 1902 associated with, or external to, a computer system containing computer 1902, with each computer 1902 communicating over network 1930. Further, the terms “client,” “user,” and other appropriate terminology can be used interchangeably, as appropriate, without departing from the scope of the present disclosure. Moreover, the present disclosure contemplates that many users can use one computer 1902 and one user can use multiple computers 1902.

Described implementations of the subject matter can include one or more features, alone or in combination.

For example, in a first implementation, a computer-implemented method includes the following. An estimate for a maximum safe rate of penetration (ROP) is determined for a well based on cutting concentrations in annulus (CCA) values within a predefined range. Hydraulics of mud pump+bit and jet impact force hydraulics are evaluated for the well. A developed hole cleaning index is determined for the well based on a carrying capacity model considering chemical and physical influences of drilling fluid rheology. A real-time Drilling Specific Energy (DSE) is determined for the well using the estimate for the maximum safe ROP, the evaluated hydraulics, and the developed hole cleaning index. Optimal drilling parameters are determined for the well using particle swarm optimization (PSO) and a penalty approach (PA). Optimal mechanical drilling parameters are determined for the well using the optimal drilling parameters and by evaluating the real-time DSE. The optimal mechanical drilling parameters are used during drilling. The real-time developed DSE is correlated with fuel consumption to assess CO₂ and toxics gases emission for environmental awareness.

The foregoing and other described implementations can each, optionally, include one or more of the following features:

A first feature, combinable with any of the following features, where the carrying capacity model considers chemical and physical influences of drilling fluid rheology for vertical and directional wells.

A second feature, combinable with any of the previous or following features, the method further including updating the real-time DSE by evaluating weight on bit (WOB), revolutions per minute (RPMs), stand pipe pressure (SPP), torque (TRQ), and flow rate in gallon per min (GPM).

A third feature, combinable with any of the previous or following features, where determining the optimal drilling parameters includes evaluating an objective function as a sum of the real-time DSE and a penalty.

A fourth feature, combinable with any of the previous or following features, where the penalty is a sum of penalty terms.

A fifth feature, combinable with any of the previous or following features, where the penalty terms include a torque term, a WOB term, a CCA term, and an RPM term.

A sixth feature, combinable with any of the previous or following features, where determining the real-time DSE includes determining the real-time DSE based at least in part on the jet impact force of a bit.

In a second implementation, a non-transitory, computer-readable medium stores one or more instructions executable by a computer system to perform operations including the following. An estimate for a maximum safe rate of penetration (ROP) is determined for a well based on cutting concentrations in annulus (CCA) values within a predefined range. Hydraulics of mud pump+bit and jet impact force hydraulics are evaluated for the well. A developed hole cleaning index is determined for the well based on a carrying capacity model considering chemical and physical influences of drilling fluid rheology. A real-time Drilling Specific Energy (DSE) is determined for the well using the estimate for the maximum safe ROP, the evaluated hydraulics, and the developed hole cleaning index. Optimal drilling parameters are determined for the well using particle swarm optimization (PSO) and a penalty approach (PA). Optimal mechanical drilling parameters are determined for the well using the optimal drilling parameters and by evaluating the real-time DSE. The optimal mechanical drilling parameters are used during drilling. The real-time developed DSE is correlated with fuel consumption to assess CO₂ and toxics gases emission for environmental awareness.

The foregoing and other described implementations can each, optionally, include one or more of the following features:

A first feature, combinable with any of the following features, where the carrying capacity model considers chemical and physical influences of drilling fluid rheology for vertical and directional wells.

A second feature, combinable with any of the previous or following features, the operations further including updating the real-time DSE by evaluating weight on bit (WOB), revolutions per minute (RPMs), stand pipe pressure (SPP), torque (TRQ), and flow rate in gallon per min (GPM).

A third feature, combinable with any of the previous or following features, where determining the optimal drilling parameters includes evaluating an objective function as a sum of the real-time DSE and a penalty.

A fourth feature, combinable with any of the previous or following features, where the penalty is a sum of penalty terms.

A fifth feature, combinable with any of the previous or following features, where the penalty terms include a torque term, a WOB term, a CCA term, and an RPM term.

A sixth feature, combinable with any of the previous or following features, where determining the real-time DSE includes determining the real-time DSE based at least in part on the jet impact force of a bit.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. An estimate for a maximum safe rate of penetration (ROP) is determined for a well based on cutting concentrations in annulus (CCA) values within a predefined range. Hydraulics of mud pump+bit and jet impact force hydraulics are evaluated for the well. A developed hole cleaning index is determined for the well based on a carrying capacity model considering chemical and physical influences of drilling fluid rheology. A real-time Drilling Specific Energy (DSE) is determined for the well using the estimate for the maximum safe ROP, the evaluated hydraulics, and the developed hole cleaning index. Optimal drilling parameters are determined for the well using particle swarm optimization (PSO) and a penalty approach (PA). Optimal mechanical drilling parameters are determined for the well using the optimal drilling parameters and by evaluating the real-time DSE. The optimal mechanical drilling parameters are used during drilling. The real-time developed DSE is correlated with fuel consumption to assess CO₂ and toxics gases emission for environmental awareness.

The foregoing and other described implementations can each, optionally, include one or more of the following features:

A first feature, combinable with any of the following features, where the carrying capacity model considers chemical and physical influences of drilling fluid rheology for vertical and directional wells.

A second feature, combinable with any of the previous or following features, the operations further including updating the real-time DSE by evaluating weight on bit (WOB), revolutions per minute (RPMs), stand pipe pressure (SPP), torque (TRQ), and flow rate in gallon per min (GPM).

A third feature, combinable with any of the previous or following features, where determining the optimal drilling parameters includes evaluating an objective function as a sum of the real-time DSE and a penalty.

A fourth feature, combinable with any of the previous or following features, where the penalty is a sum of penalty terms.

A fifth feature, combinable with any of the previous or following features, where the penalty terms include a torque term, a WOB term, a CCA term, and an RPM term.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
determining an estimate for a maximum safe rate of penetration (ROP) for a well based on cutting concentrations in annulus (CCA) values within a predefined range;
evaluating hydraulics of mud pump+bit and jet impact force hydraulics for the well;
determining a developed hole cleaning index for the well based on a carrying capacity model considering chemical and physical influences of drilling fluid rheology;
determining a real-time Drilling Specific Energy (DSE) for the well using the estimate for the maximum safe ROP, the evaluated hydraulics, and the developed hole cleaning index;
determining optimal drilling parameters for the well using particle swarm optimization (PSO) and a penalty approach (PA);
determining optimal mechanical drilling parameters for the well using the optimal drilling parameters and by evaluating the real-time DSE;
using the optimal mechanical drilling parameters during drilling; and
correlating real-time developed DSE with fuel consumption to assess CO₂ and toxics gases emission for environmental awareness.

2. The computer-implemented method of claim 1, wherein the carrying capacity model considers chemical and physical influences of drilling fluid rheology for vertical and directional wells.

3. The computer-implemented method of claim 1, further comprising updating the real-time DSE by evaluating weight on bit (WOB), revolutions per minute (RPMs), stand pipe pressure (SPP), torque (TRQ), and flow rate in gallon per min (GPM).

4. The computer-implemented method of claim 1, wherein determining the optimal drilling parameters includes evaluating an objective function as a sum of the real-time DSE and a penalty.

5. The computer-implemented method of claim 4, wherein the penalty is a sum of penalty terms.

6. The computer-implemented method of claim 5, wherein the penalty terms include a torque term, a WOB term, a CCA term, and an RPM term.

7. The computer-implemented method of claim 1, wherein determining the real-time DSE includes determining the real-time DSE based at least in part on the jet impact force of a bit.

8. A non-transitory, computer-readable medium storing one or more instructions executable by a computer system to perform operations comprising:
determining an estimate for a maximum safe rate of penetration (ROP) for a well based on cutting concentrations in annulus (CCA) values within a predefined range;
evaluating hydraulics of mud pump+bit and jet impact force hydraulics for the well;
determining a developed hole cleaning index for the well based on a carrying capacity model considering chemical and physical influences of drilling fluid rheology;
determining a real-time Drilling Specific Energy (DSE) for the well using the estimate for the maximum safe ROP, the evaluated hydraulics, and the developed hole cleaning index;
determining optimal drilling parameters for the well using particle swarm optimization (PSO) and a penalty approach (PA);
determining optimal mechanical drilling parameters for the well using the optimal drilling parameters and by evaluating the real-time DSE;
using the optimal mechanical drilling parameters during drilling; and
correlating real-time developed DSE with fuel consumption to assess CO₂ and toxics gases emission for environmental awareness.

9. The non-transitory, computer-readable medium of claim 8, wherein the carrying capacity model considers chemical and physical influences of drilling fluid rheology for vertical and directional wells.

10. The non-transitory, computer-readable medium of claim 8, the operations further comprising updating the real-time DSE by evaluating weight on bit (WOB), revolutions per minute (RPMs), stand pipe pressure (SPP), torque (TRQ), and flow rate in gallon per min (GPM).

11. The non-transitory, computer-readable medium of claim 8, wherein determining the optimal drilling parameters includes evaluating an objective function as a sum of the real-time DSE and a penalty.

12. The non-transitory, computer-readable medium of claim 11, wherein the penalty is a sum of penalty terms.

13. The non-transitory, computer-readable medium of claim 12, wherein the penalty terms include a torque term, a WOB term, a CCA term, and an RPM term.

14. The non-transitory, computer-readable medium of claim 8, wherein determining the real-time DSE includes determining the real-time DSE based at least in part on the jet impact force of a bit.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
determining an estimate for a maximum safe rate of penetration (ROP) for a well based on cutting concentrations in annulus (CCA) values within a predefined range;
evaluating hydraulics of mud pump+bit and jet impact force hydraulics for the well;
determining a developed hole cleaning index for the well based on a carrying capacity model considering chemical and physical influences of drilling fluid rheology;
determining a real-time Drilling Specific Energy (DSE) for the well using the estimate for the maximum safe ROP, the evaluated hydraulics, and the developed hole cleaning index;
determining optimal drilling parameters for the well using particle swarm optimization (PSO) and a penalty approach (PA);
determining optimal mechanical drilling parameters for the well using the optimal drilling parameters and by evaluating the real-time DSE;
using the optimal mechanical drilling parameters during drilling; and
correlating real-time developed DSE with fuel consumption to assess CO₂ and toxics gases emission for environmental awareness.

16. The computer-implemented system of claim 15, wherein the carrying capacity model considers chemical and physical influences of drilling fluid rheology for vertical and directional wells.

17. The computer-implemented system of claim 15, the operations further comprising updating the real-time DSE by evaluating weight on bit (WOB), revolutions per minute (RPMs), stand pipe pressure (SPP), torque (TRQ), and flow rate in gallon per min (GPM).

18. The computer-implemented system of claim 15, wherein determining the optimal drilling parameters includes evaluating an objective function as a sum of the real-time DSE and a penalty.

19. The computer-implemented system of claim 18, wherein the penalty is a sum of penalty terms.

20. The computer-implemented system of claim 19, wherein the penalty terms include a torque term, a WOB term, a CCA term, and an RPM term.
